(19) United States
(12) Patent Application Publication
(10) Pub. No.: US 2008/0062002 A1
(43) Pub. Date: Mar. 13, 2008

(54) INFORMATION PROCESSING APPARATUS AND REMOTE-CONTROL CODE TRANSMISSION CONTROL METHOD

(75) Inventor: Keiichi Uehara, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 11/855,028

(22) Filed: Sep. 13, 2007

(30) Foreign Application Priority Data
Sep. 13, 2006 (JP) 2006-248479

(51) Int. Cl. H04Q 7/16

(52) U.S. Cl. 340/825.52

(57) ABSTRACT

According to one embodiment, a first interface unit executes a process of transmitting a remote-control code belonging to a first remote-control code set which is supported by a first operating system (OS#1) to an operating system which is currently executed. A second interface unit executes a process of transmitting a remote-control code belonging to a second remote-control code set which is supported by a second operating system (OS#2) to the currently executed operating system. If the currently executed operating system is OS#1, a control unit prohibits transmission of the remote-control code from a receiving unit to the second interface unit, and permits the first interface unit to execute the process. If the currently executed operating system is OS#2, the control unit permits transmission of the remote-control code from the receiving unit to the second interface unit, and prohibits execution of the process by the first interface unit.

### CROSS-REFERENCE TO RELATED APPLICATIONS

This application is based upon and claims the benefit of priority from Japanese Patent Application No. 2006-248479, filed Sep. 13, 2006, the entire contents of which are incorporated herein by reference.

### BACKGROUND

1. Field

One embodiment of the present invention relates to an information processing apparatus, such as a personal computer, which includes a receiving unit for receiving, for example, a remote-control code which is sent from a remote-control unit.

2. Description of the Related Art

In general, an audio/video (AV) apparatus, such as a video tape recorder or a TV apparatus, is configured to execute various functions corresponding to various remote-control codes which are transmitted from a remote-control unit.

Jpn. Pat. Appln. KOKAI Publication No. 11-53873 discloses a system including a video tape recorder and a TV apparatus which is connected to the video tape recorder. The video tape recorder and the TV apparatus are equipped with light-receiving units, respectively. In this system, not only the light-receiving unit of the video tape recorder but also the light-receiving unit of the TV apparatus can receive a remote-control code for controlling a microcomputer which is provided in the video tape recorder.

In the meantime, in recent years, there is a demand for realization of an AV function in a personal computer, which is similar to an AV function in an AV apparatus. In this type of personal computer, like the AV apparatus, it is necessary to control various operations of the personal computer only by operating a remote-control unit.

However, in usual cases, the kind of remote-control codes, which can be supported, varies from operating system to operating system. Thus, if the number of kinds of operating systems, to which the personal computer is adaptable, increases, the number of kinds of remote-control units, to which the personal computer is required to be adaptable, increases accordingly. Moreover, in usual cases, the kind of interface, which is necessary in order to receive remote-control codes, varies from operating system to operating system.

If such a system configuration that a plurality of remote-control units are associated with a plurality of light-receiving units in one-to-one correspondence is adopted in order to support a plurality of operating systems, it would become necessary to equip the personal computer with a plurality of light-receiving units. This leads to an increase in number of components. In addition, in the personal computer having the plural light-receiving units, a remote-control code from the remote-control unit is received by the plural light-receiving units, and it is possible that the same remote-control code is repeatedly sent to the operating system. This may cause malfunction of the operating system.

It is thus necessary to realize a novel function which can individually control a plurality of kinds of operating systems which support different kinds of remote-control codes, without providing a plurality of receiving units (light-receiving units) for receiving

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the external appearance of an information processing apparatus according to an embodiment of the invention;

FIG. 2 is an exemplary block diagram showing a system configuration of the information processing apparatus shown in FIG. 1;

FIG. 3 is an exemplary block diagram showing a functional configuration of a BIOS which is used in the information processing apparatus shown in FIG. 1;

FIG. 4 is an exemplary block diagram showing a hardware configuration of a receiving unit and its peripheral parts, which are provided in the information processing apparatus shown in FIG. 1;

FIG. 5 is an exemplary flowchart showing a procedure of a remote-control code transmission process which is executed by the information processing apparatus shown in FIG. 1;

FIG. 6 is an exemplary view for explaining the relationship between the kinds of operating systems and remote-control interfaces, which are used in the information processing apparatus shown in FIG. 1;

FIG. 7 is an exemplary block diagram showing another example of the hardware configuration of the receiving unit and its peripheral parts, which are provided in the information processing apparatus shown in FIG. 1; and

FIG. 8 is an exemplary flowchart showing another procedure of the remote-control code transmission process which is executed by the information processing apparatus shown in FIG. 1.

### DETAILED DESCRIPTION

Various embodiments according to the invention will be described hereinafter with reference to the accompanying drawings. In general, according to one embodiment of the invention, an information processing apparatus includes: a receiving unit configured to receive a remote-control code which is sent from a first remote-control unit or a second remote-control unit, the first remote-control unit including buttons to which a first remote-control code set supported by a first operating system is assigned, and the second remote-control unit including buttons to which a second remote-control code set supported by a second operating system is assigned; a first interface unit connected to the receiving unit, configured to execute a remote-control code process of transmitting the remote-control code belonging to the first remote-control code set, which is transmitted from the receiving unit, to an operating system which is currently executed by the information processing apparatus; a second interface unit connected to the receiving unit, configured to execute a remote-control code process of transmitting the remote-control code belonging to the second remote-control code set, which is transmitted from the receiving unit, to an operating system which is currently executed by the information processing apparatus; a determination unit configured to determine whether the operating system, which is currently executed by the information processing apparatus, is the first operating system or the second operating system; and a control unit configured to prohibit, if the operating system that is currently executed by the information processing apparatus is the first operating system, transmission of the remote-control code from the receiving unit to the second interface unit, and permit the first interface unit to execute the remote-control code process, and configured to permit, if the operating system that is currently executed by the information processing apparatus is the second operating system, transmission of the remote-control code from the receiving unit to the second interface unit, and prohibit execution of the remote-control code process by the first interface unit.

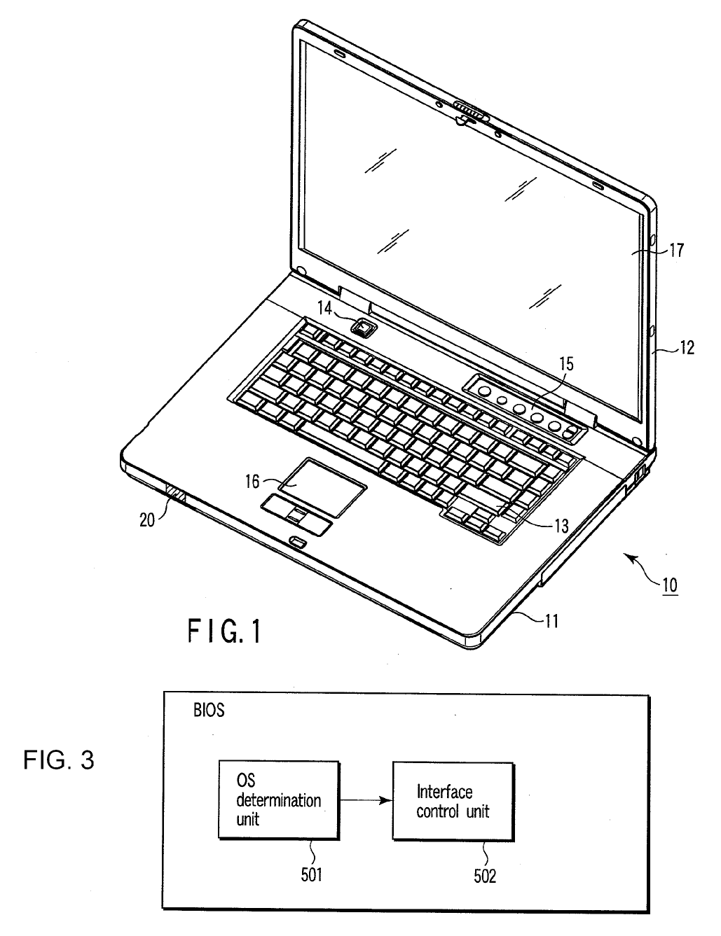

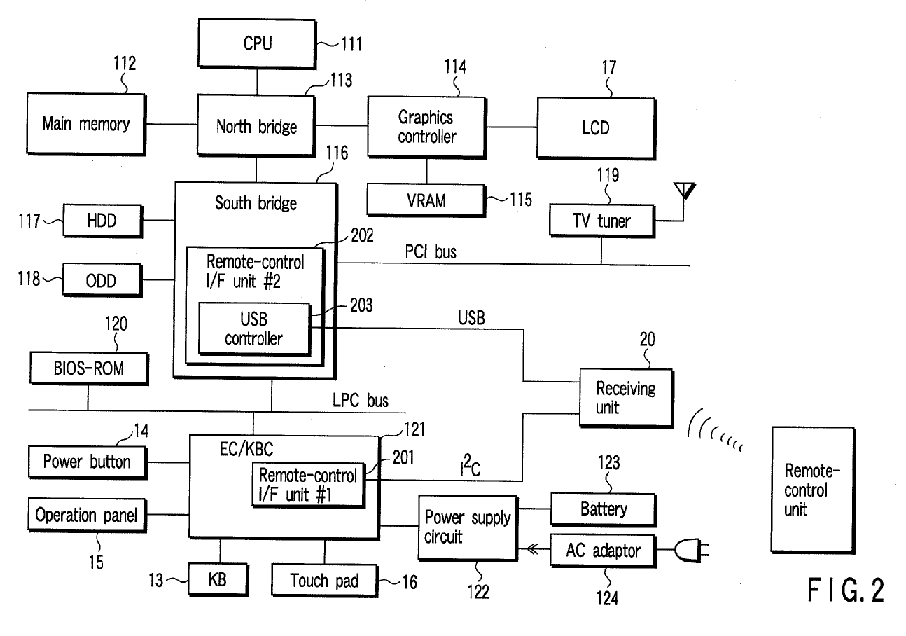

To begin with, referring to FIG. 1 and FIG. 2, the structure of an information processing apparatus according to an embodiment of the invention is described. The information processing apparatus is realized, for example, as a notebook-type portable personal computer 10.

FIG. 1 is a perspective view of the computer 10 in the state in which a display unit of the personal computer 10 is opened. The computer 10 comprises a computer main body 11 and a display unit 12.

A display device that is composed of a TFT-LCD (Thin-Film Transistor Liquid Crystal Display) 17 is built in the display unit 12. The display unit 12 is attached to the computer main body 11 such that the display unit 12 is freely rotatable, relative to the computer main body 11, between an open position and a closed position

The computer main body 11 has a thin box-shaped casing. A keyboard 13, a power button 14 for powering on/off the computer 10, an operation panel 15 including various operation buttons, and a touch pad 16 are disposed on the top surface of the computer main body 11.

On the front surface of the computer main body 11, a receiving unit 20 is provided for receiving a remote-control signal which is sent from an external remote-control unit for remote-controlling the functions of the computer 10. The receiving unit 20 includes a light-receiving unit for receiving an infrared signal.

FIG. 2 is a block diagram showing the system configuration of the computer 10.

The computer 10, as shown in FIG. 2, comprises a CPU 111, a main memory 112, a north bridge 113, a graphics controller 114, a video memory (VRAM) 115, a south bridge 116, a hard disk drive (HDD) 117, an optical disc drive (ODD) 118, a TV tuner 119, a BIOS-ROM 120, an embedded controller/keyboard controller IC (EC/KBC) 121, and a power supply circuit 122.

The CPU 111 is a processor that controls the operation of the computer 10. The CPU 111 executes an operating system and various application programs, which are loaded from the hard disk drive (HDD) 117 into the main memory 112. In the computer 10, a first operating system (hereinafter referred to as “OS#1”) or a second operating system (hereinafter “OS#2”) is preinstalled in the hard disk drive (HDD) 117.

If the OS#1 is installed, the OS#1 is booted up in response to power-on of the computer 10. On the other hand, if the OS#2 is installed, the OS#2 is booted up in response to power-on of the computer 10.

The OS#1 is configured to support a first remote-control code set. Specifically, the OS#1 can execute functions corresponding to remote-control codes belonging to the first remote-control code set. Upon receiving a remote-control code belonging to the first remote-control code set, the OS#1 executes the function corresponding to the received remote-control code.

The first remote-control code set includes, for instance, a remote-control code which instructs power-on/power-off of the computer 10, a remote-control code for starting a specified application program, and a remote-control code for moving a cursor.

The OS#2 is configured to support a second remote-control code set which is different from the first remote-control code set. Specifically, the OS#2 can execute functions corresponding to remote-control codes belonging to the second remote-control code set. Upon receiving a remote-control code belonging to the second remote-control code set, the OS#2 executes the function corresponding to the received remote-control code.

The second remote-control code set includes, for instance, a remote-control code which instructs power-on/power-off of the computer 10, some remote-control codes for controlling reproduction of audio data, some remote-control codes for controlling reproduction of video data, some remote-control codes for controlling reception and reproduction of TV broadcast programs, and a remote-control code for moving the cursor.

The remote-control code which instructs power-on/power-off of the computer 10 and the remote-control code for moving the cursor are remote-control codes which are common between the first remote-control code set and the second remote-control code set.

The CPU 111 also executes a BIOS (Basic Input/Output System) that is stored in the BIOS-ROM 120. The system BIOS is a program for hardware control.

The north bridge 113 is a bridge device that connects a local bus of the CPU 111 and the south bridge 116. The north bridge 113 includes a memory controller that controls the main memory 112. In addition, the north bridge 113 has a function of executing communication with the graphics controller 114 via, e.g. an AGP (Accelerated Graphics Port) bus.

The graphics controller 114 is a display controller which controls an LCD 17 that is used as a display monitor of the computer 10. The graphics controller 114 sends to the LCD 17 a video signal corresponding to display data that is written in the video memory (VRAM) 115 by the OS or application program.

The south bridge 116 controls devices on an LPC (Low Pin Count) bus, and devices on a PCI (Peripheral Component Interconnect) bus. In addition, the south bridge 116 includes an IDE (Integrated Drive Electronics) controller for controlling the HDD 117 and ODD 118.

The HDD 117 is a storage device which stores various software and data. The optical disc drive (ODD) 118 is a drive unit for controlling, e.g. DVD media on which video content, such as a DVD title, is stored, and CD media on which music data is stored. The TV tuner 119 is a device for receiving TV broadcast program data, and is connected to the PCI bus.

The embedded controller/keyboard controller IC (EC/KBC) 121 is a 1-chip microcomputer in which an embedded controller for power management and a keyboard controller for controlling the keyboard (KB) 13 and touch pad 16 are integrated. The EC/KBC 121 is always powered on by power from the power supply circuit 122, regardless of whether the computer 10 is powered on or powered off. The EC/KBC 121 cooperates with the power supply circuit 122 to execute a process of powering on/off the computer 10 in response to the user's operation of the power button switch 14. The power supply circuit 122 generates power, which is to be supplied to the components of the computer 10, using power from a battery 123 which is built in the computer 10 or using external power supplied via an AC adapter 124.

Further, the computer 10 includes a first remote-control interface unit 201 and a second remote-control interface unit 202. Each of the remote-control interface units 201 and 202 is an interface for transmitting to the operating system a remote-control code which is received by the receiving unit 20 from an external remote-control unit.

The first remote-control interface unit 201 is an interface unit which is mainly used for interface between the receiving unit 20 and the OS#1. The first remote-control interface unit 201 is provided, for example, in the EC/KBC 121, and is connected to the receiving unit 20 via a signal line such as an I²C (Inter-IC) bus. The first remote-control interface unit 201 executes a remote-control code process which transmits remote-control codes (including common remote-control codes) belonging to the first remote-control code set, which are sent from the receiving unit 20, to the operating system which is currently executed by the CPU 111. The first remote-control interface unit 201 is configured to be able to transmit to the operating system all remote-control codes (including common remote-control codes) belonging to the first remote-control code set.

Specifically, if a remote-control code, which is received by the first remote-control interface unit 201 from the receiving unit 20, is one of remote-control codes (including common remote-control codes) belonging to the first remote-control code set, the first remote-control interface unit 201 executes a remote-control code process which transmits the received remote-control code to the operating system that is currently executed by the CPU 111. On the other hand, if received remote-control code is a remote-control code not belonging to the first remote-control code set (including common remote-control codes), the first remote-control interface unit 201 discards the received remote-control code.

The transmission of the remote-control code from the first remote-control interface unit 201 to the operating system is executed by making use of communication between the first remote-control interface unit 201 and the operating system.

The second remote-control interface unit 202 is an interface unit which is mainly used for interface between the receiving unit 20 and the OS#2. The second remote-control interface unit 202 is provided, for example, in the south bridge 116, and is connected to the receiving unit 20 via a signal line such as a USB (Universal Serial Bus). The second remote-control interface unit 202 executes a remote-control code process which transmits remote-control codes (including common remote-control codes) belonging to the second remote-control code set, which are sent from the receiving unit 20, to the operating system which is currently executed by the CPU 111. The second remote-control interface unit 202 is configured to be able to transmit to the operating system all remote-control codes (including common remote-control codes) belonging to the second remote-control code set. The second remote-control interface unit 202 is composed of, e.g. a USB controller 203.

The transmission of the remote-control code from the second remote-control interface unit 202 to the operating system is executed by making use of communication between the second remote-control interface unit 202 and the operating system.

The computer 10 has a remote-control code transmission control function for executing, with use of the single receiving unit 20, the control of a first remote-control unit corresponding to the OS#1 and the control of a second remote-control unit corresponding to the OS#2. The first remote-control unit has buttons to which the first remote-control code set is assigned. The first remote-control unit outputs a remote-control code corresponding to the button, which is pressed by the user, by an infrared signal. The second remote-control unit has buttons to which the second remote-control code set is assigned. The second remote-control unit outputs a remote-control code corresponding to the button, which is pressed by the user, by an infrared signal.

The first remote-control unit and the second remote-control unit correspond to the OS#1 and OS#2 in one-to-one correspondence. Thus, in the case where the OS#1 is installed in the computer 10, the user operates the first remote-control unit in order to control the operation of the computer 10. In the case where the OS#2 is installed in the computer 10, the user operates the second remote-control unit in order to control the operation of the computer 10.

Needless to say, in the case where the operating system is caused to execute a function corresponding to the common remote-control code, the user may use either of the first remote-control unit and second remote-control unit, regardless of the kind of the operating system that is currently executed.

The remote-control code transmission control function is a function for enabling both of the first and second remote-control units to be used by the single receiving unit that is built in the computer 10. This remote-control code transmission control function is realized by switching, in accordance with the kind of the operating system executed by the computer 10, the path for transmitting the remote-control code from the receiving unit 20 to the operating system between a path extending through the first remote-control interface unit 201 and a path extending through the second remote-control interface unit 202.

If the operating system which is currently executed by the computer 10 is the OS#1, only the path extending through the first remote-control interface unit 201 is rendered effective, and the path extending through the second remote-control interface unit 202 is rendered non-effective. Thus, all remote-control codes, which are sent from the first remote-control unit, are transmitted to the OS#1 via the receiving unit 20 and the first remote-control interface unit 201. Since the first remote-control interface unit 201 can handle all the remote-control codes belonging to the first remote-control code set, all remote-control codes, which are sent from the first remote-control unit, can normally be transmitted to the OS#l. Since the second remote-control interface unit 202 is rendered non-effective, it is possible to prevent the remote-control code, such as a common remote-control code, from being erroneously transmitted doubly to the OS#1 via both the first remote-control interface unit 201 and the second remote-control interface unit 202.

On the other hand, if the operating system which is currently executed by the computer 10 is the OS#2, only the path extending through the second remote-control interface unit 202 is rendered effective, and the path extending through the first remote-control interface unit 201 is rendered non-effective. Thus, all remote-control codes which are sent from the second remote-control unit are transmitted to the OS#2 via the receiving unit 20 and the second remote-control interface unit 202. Since the second remote-control interface unit 202 can handle all the remote-control codes belonging to the second remote-control code set, all remote-control codes, which are sent from the second remote-control unit, can normally be transmitted to the OS#2. Since the first remote-control interface unit 201 is rendered non-effective, it is possible to prevent the remote-control code, such as a common remote-control code, from being erroneously transmitted doubly to the OS#2 via both the first remote-control interface unit 201 and the second remote-control interface unit 202.

The above-described remote-control code transmission control function is executed by the BIOS.

FIG. 3 shows the functional configuration of the BIOS.

The BIOS includes an OS determination unit 501 and an interface control unit 502 as software modules for executing the remote-control code transmission control function. The OS determination unit 501 determines whether the operating system, which is currently executed by the computer 10, is the OS#1 or the OS#2.

The interface control unit 502 is a control unit which executes a process of selectively enabling the first remote-control interface unit 201 and second remote-control interface unit 202 in accordance with a determination result obtained by the OS determination unit 501.

If the OS determination unit 501 determines that the operating system, which is currently executed by the computer 10, is the OS#1, the interface control unit 502 prohibits transmission of a remote-control code from the receiving unit 20 to the second remote-control interface unit 202 and permits the first remote-control interface unit 201 to execute the remote-control code process. As a result, only the path extending through the first remote-control interface unit 201 can be rendered effective, and the path extending through the second remote-control interface unit 202 can be rendered non-effective.

On the other hand, if the OS determination unit 501 determines that the operating system, which is currently executed by the computer 10, is the OS#2, the interface control unit 502 permits transmission of a remote-control code from the receiving unit 20 to the second remote-control interface unit 202 and prohibits the first remote-control interface unit 201 from executing the remote-control code process. As a result, only the path extending through the second remote-control interface unit 202 can be rendered effective, and the path extending through the first remote-control interface unit 201 can be rendered non-effective. Even if the execution of the remote-control code process by the first remote-control interface unit 201 is prohibited, the transmission of the remote-control code from the receiving unit 20 to the first remote-control interface unit 201 is not prohibited. Thus, the first remote-control interface unit 201 can receive, for example, the remote-control code which instructs power-on of the computer 10 and is sent from the second remote-control unit. The first remote-control interface unit 201, which is provided in the EC/KBC 121, is always supplied with power. Hence, the first remote-control interface unit 201 can execute, in cooperation with the power supply circuit 122, the process for powering on the computer 10 in response to reception of the remote-control code which instructs power-on of the computer 10 and is sent from the first remote-control unit or the second remote-control unit.

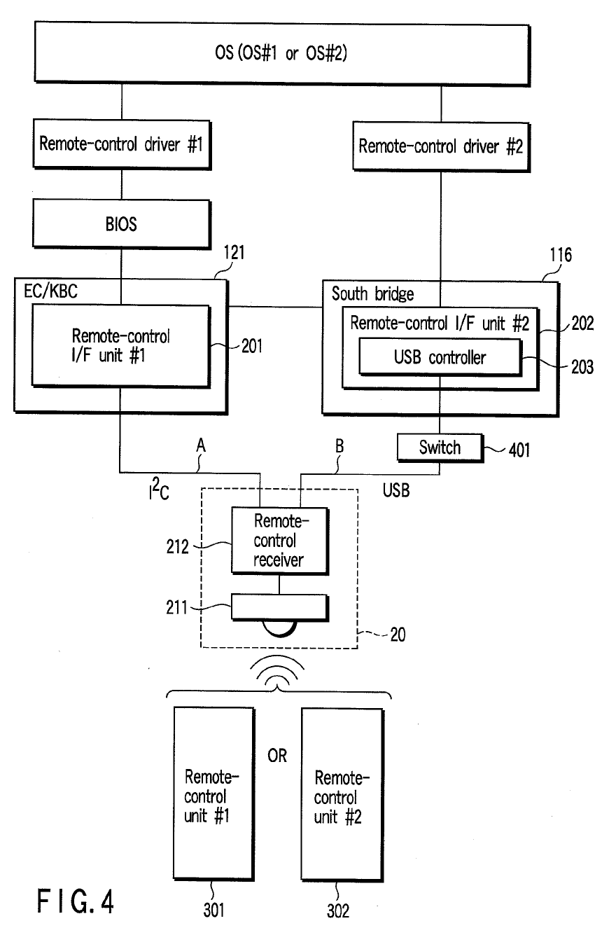

Next, referring to FIG. 4, the hardware configuration for realizing the remote-control code transmission control function is described.

FIG. 4 shows the hardware configuration of the receiving unit 20 and its peripheral components.

In the present embodiment, as described above, two kinds of remote-control units are supported. A remote-control unit 301 is the above-described first remote-control unit and is used to control the OS#1. A remote-control unit 302 is the above-described second remote-control unit and is used to control the OS#2.

The receiving unit 20 receives a remote-control code which is sent from the first remote-control unit 301 or second remote-control unit 302. The receiving unit 20 includes a light-receiving unit 211 and a remote-control receiver 212.

The light-receiving unit 211 receives an infrared signal which is sent from the first remote-control unit 301 or second remote-control unit 302. The infrared signal that is received by the light-receiving unit 211 is converted to an electric signal by the light-receiving unit 211. The remote-control receiver 212 is configured to be able to extract both the first remote-control code set and second remote-control code set from the infrared signal received by the light-receiving unit 211. Specifically, the remote-control receiver 212 demodulates the infrared signal that is received by the light-receiving unit 211, and thus can extract each remote-control code belonging to the first remote-control code set and each remote-control code belonging to the second remote-control code set from the infrared signal which is received by the light-receiving unit 211, that is, the electric signal which is output from the light-receiving unit 211. The remote-control receiver 212 transmits each of the extracted remote-control codes to the first remote-control interface unit 201 via a signal line A such as an I²C bus, and transmits said each of the extracted remote-control codes to the second remote-control interface unit 202 via a signal line B such as a USB.

A switch circuit 401 is connected between the remote-control receiver 212 in the receiving unit 20 and the second remote-control interface unit 202. The switch circuit 401 is composed of, e.g. a transfer gate. The BIOS turns on/off the switch circuit 401, thus being able to permit or prohibit transmission of the remote-control code from the receiving unit 20 to the second remote-control interface unit 202. A switch control signal for turning on/off the switch circuit 401 is output, for example, from the EC/KBC 121. The BIOS writes data, which instructs turning on/off the switch circuit 401, in a register that is provided within the EC/KBC 121, thus being able to cause the EC/KBC 121 to output the switch control signal for turning on/off the switch circuit 401.

If the operating system that is currently executed is the OS#1, the remote-control unit that is operated by the user is basically the remote-control unit 301. Accordingly, in the case where the OS#1 is booted up, the remote-control code from the remote-control unit 301 is transmitted to the first remote-control interface 201 via the receiving unit 20 and signal line A. Since the signal line B is disconnected by the switch circuit 401, the remote-control code is not transmitted to the second remote-control interface unit 202. Hence, the remote-control code, such as the common remote-control code, is not erroneously transmitted doubly to the OS#1.

The first remote-control interface unit 201 executes the remote-control process for transmitting the received remote-control code to the operating system that is currently executed. The transmission of the remote-control code from the first remote-control interface unit 201 to the operating system is executed, for example, via the BIOS and a first remote-control driver (remote-control driver #1). The first remote-control driver (remote-control driver #1) is realized, for example, as a driver program corresponding to the OS#1, and transmits the remote-control code, which is received from the first remote-control interface unit 201, to the OS#1. In this case, if the remote-control code, which is received from the first remote-control interface unit 201, is a remote-control code which instructs activation of a specified application, the first remote-control driver (remote-control driver #1) converts this remote-control code to a command which instructs the activation of the specified application, and sends the command to the OS#1.

If the operating system that is currently executed is the OS#2, the remote-control unit that is operated by the user is basically the remote-control unit 302. The switch circuit 401 is turned on by the BIOS. Accordingly, in the case where the OS#2 is booted up, the remote-control code from the remote-control unit 302 is transmitted to the first remote-control interface 201 via the signal line A and to the second remote-control interface 201 via the signal line B. Since the execution of the remote-control process by the first remote-control interface unit 201 is prohibited by the BIOS, the transmission of the remote-control code from the first remote-control interface unit 201 to the OS is not executed. Hence, the remote-control code, such as the common remote-control code, is not erroneously transmitted doubly to the OS#2.

The second remote-control interface unit 202 transmits the remote-control code, which is sent from the remote-control unit 302, to the operating system (OS#2) that is currently executed. The transmission of the remote-control code from the second remote-control interface unit 202 to the operating system (OS#2) is executed, for example, via a second remote-control driver (remote-control driver #2). The second remote-control driver (remote-control driver #2) is, for example, a driver program corresponding to the OS#2, and is realized as a driver program for accessing a USB device, which is called an HID (Human Interface Device), via a USB controller 203.

Next, referring to a flowchart of FIG. 5, a description is given of the procedure of the remote-control code transmission control process which is executed by the BIOS, that is, by the CPU 111.

Upon power-on of the computer 10, the BIOS starts a process of booting up the operating system (OS#1 or OS#2) that is stored in the HDD 117 (block S101). The BIOS then determines the kind of the booted-up operating system by reading OS identification information that is described in, e.g. a boot loader of the operating system (block S102). In block S102, the BIOS determines whether the booted-up operating system is the OS#1 or the OS#2.

If the booted-up operating system is the OS#1 (YES in block S102), the BIOS turns off the switch circuit 401 in order to prohibit transmission of the remote-control code from the receiving unit 20 to the second remote-control interface unit 202 (block S104). Then, the BIOS sends a command to the EC/KBC 121 and permits the first remote-control interface unit 201 to execute the remote-control code process (block S105).

If the booted-up operating system is the OS#2 (NO in block S103), the BIOS turns on the switch circuit 401 in order to permit transmission of the remote-control code from the receiving unit 20 to the second remote-control interface unit 202 (block S106). Then, the BIOS sends a command to the EC/KBC 121, thereby prohibiting execution of the remote-control process by the first remote-control interface unit 201 (block S107).

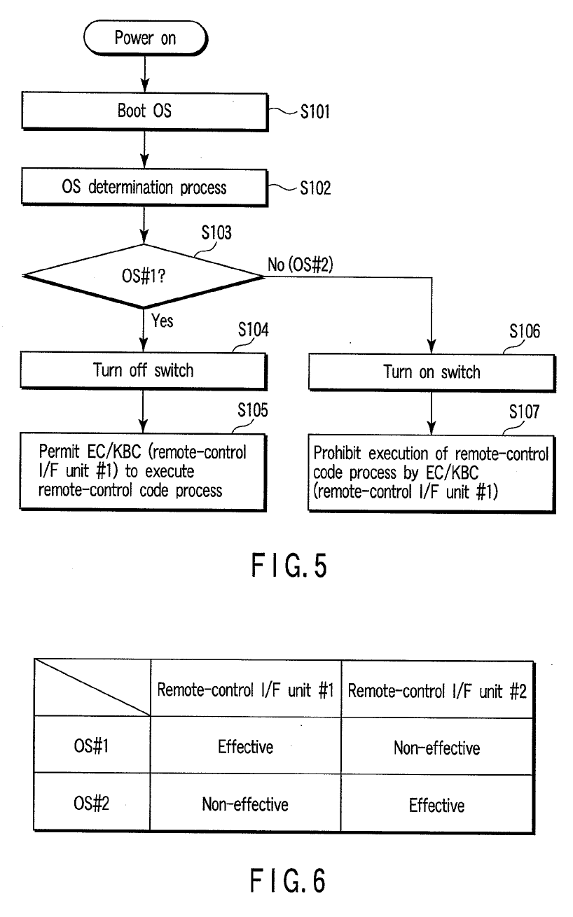

FIG. 6 shows the relationship between the kinds of operating systems that are executed and the two remote-control interface units 201 and 202.

If the operating system that is executed is the OS#1, the transmission path of the remote-control code, which extends through the first remote-control interface unit 201, is rendered effective, and the transmission path of the remote-control code, which extends through the second remote-control interface unit 202, is rendered non-effective. If the operating system that is executed is the OS#2, the transmission path of the remote-control code, which extends through the first remote-control interface unit 201, is rendered non-effective, and the transmission path of the remote-control code, which extends through the second remote-control interface unit 202, is rendered effective.

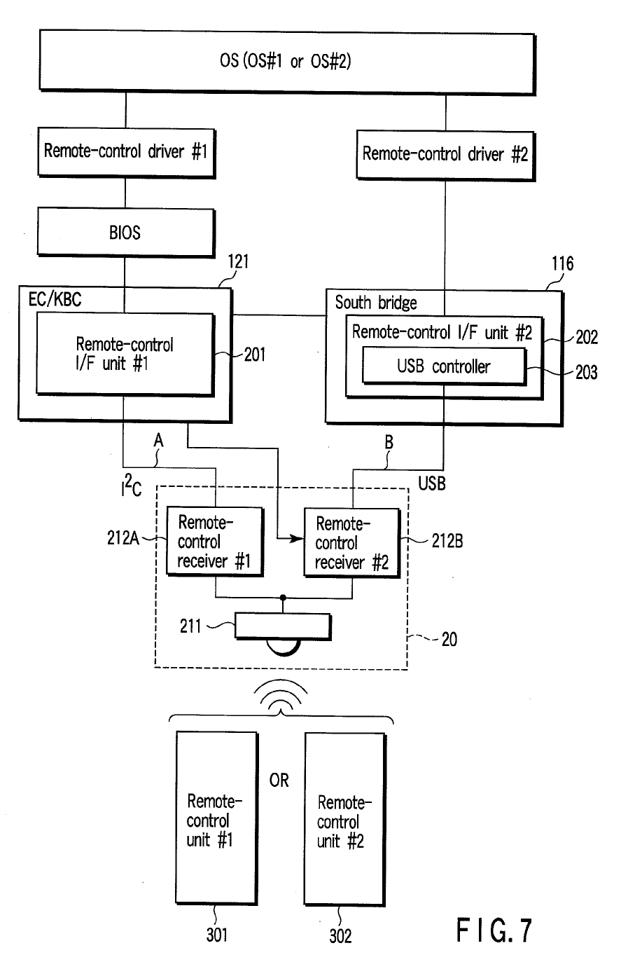

Next, referring to FIG. 7, a description is given of another example of the hardware configuration for realizing the remote-control code transmission control function.

The receiving unit 20 includes a light-receiving unit 211 and two remote-control receivers 212A and 212B. An infrared signal that is received by the light-receiving unit 211 is delivered to both the remote-control receivers 212A and 212B.

The remote-control receiver 212A is a receiver for outputting a remote-control code corresponding to the OS#1, and is configured to extract the first remote-control code set (including common remote-control codes) from the infrared signal that is received by the light-receiving unit 211. Specifically, the remote-control receiver 212A demodulates the infrared signal that is received by the light-receiving unit 211, thereby extracting a remote-control code belonging to the first remote-control code set (including common remote-control codes) from the infrared signal which is received by the light-receiving unit 211, that is, the electric signal which is output from the light-receiving unit 211, and transmitting the extracted remote-control code to the first remote-control interface unit 201 via the signal line A.

The remote-control receiver 212B is a receiver for outputting a remote-control code corresponding to the OS#2, and is configured to extract the second remote-control code set (including common remote-control codes) from the infrared signal that is received by the light-receiving unit 211. Specifically, the remote-control receiver 212B demodulates the infrared signal that is received by the light-receiving unit 211, thereby extracting a remote-control code belonging to the second remote-control code set (including common remote-control codes) from the infrared signal which is received by the light-receiving unit 211, that is, the electric signal which is output from the light-receiving unit 211, and transmitting the extracted remote-control code to the second remote-control interface unit 202 via the signal line B.

As described above, by providing the two remote-control receivers 212A and 212B corresponding to the OS#1 and OS#2, it becomes possible to output remote-control codes, which correspond to code systems supported by the OS#1 and OS#2, to the OS#1 and OS#2, respectively. For example, the remote-control receiver 212A can convert the remote-control codes belonging to the first remote-control code set (including common remote-control codes) to codes for the OS#1, and output the codes for the OS#1. The remote-control receiver 212B can convert the remote-control codes belonging to the second remote-control code set (including common remote-control codes) to codes for the OS#2, and output the codes for the OS#2. Thus, even in the case where a remote-control code corresponding to a certain common function is different between the OS#1 and OS#2, it becomes possible to transmit correct remote-control codes corresponding to the common function to the OS#1 and OS#2, respectively.

The above-described switch circuit 401 is not inserted in the signal line B. The remote-control receiver 212B is set in an active state (e.g. power-on state) or an inactive state (e.g. power-off state) by a control signal from the EC/KBC 121. The BIOS permits or prohibits the operation of the remote-control receiver 212B by controlling the control signal that is output from the EC/KBC 121, thereby to permit or prohibit transmission of the remote-control code from the receiving unit 20 to the second remote-control interface unit 202.

Specifically, if the operating system that is currently executed by the computer 10 is the OS#1, the remote-control receiver 212B is set in the inactive state by the BIOS. Since the remote-control receiver 212B does not operate, the remote-control code that is received by the receiving unit 20 is not transmitted to the second remote-control interface unit 202 and is transmitted only to the first remote-control interface unit 201.

On the other hand, if the operating system that is currently executed by the computer 10 is the OS#2, the remote-control receiver 212B is set in the active state by the BIOS. In this case, the remote-control code that is received by the receiving unit 20 is transmitted to the first remote-control interface unit 201 and second remote-control interface unit 202. Since the execution of the remote-control code process by the first remote-control interface unit 201 is prohibited by the BIOS, the transmission of the remote-control code from the first remote-control interface unit 201 to the OS#1 is not executed.

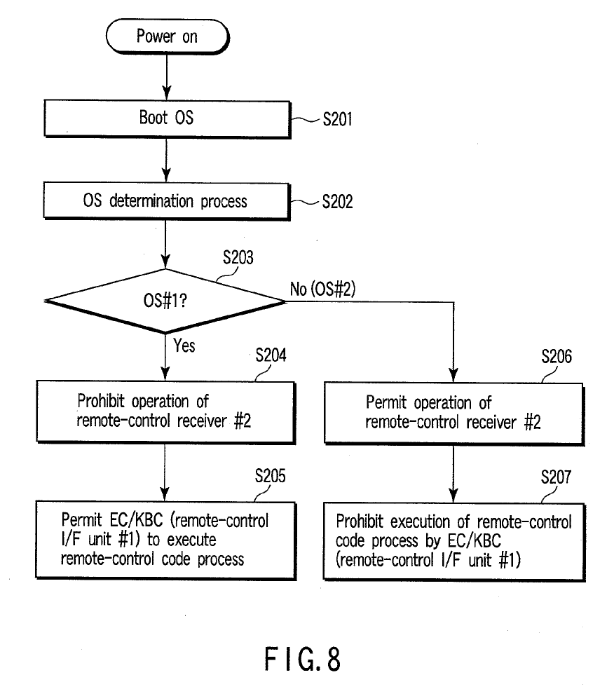

Next, referring to a flowchart of FIG. 8, a description is given of another example of the procedure of the remote-control code transmission control process which is executed by the BIOS, that is, by the CPU 111. The procedure illustrated in FIG. 8 corresponds to the structure shown in FIG. 7.

Upon power-on of the computer 10, the BIOS starts a process of booting up the operating system (OS#1 or OS#2) that is stored in the HDD 117 (block S201). The BIOS then determines the kind of the booted-up operating system by reading OS identification information that is described in, e.g. a boot loader of the operating system (block S202). In block S202, the BIOS determines whether the booted-up operating system is the OS#1 or the OS#2.

If the booted-up operating system is the OS#1 (YES in block S202), the BIOS sets the remote-control receiver 212B in an inactive state (e.g. power-off state) and prohibits the operation of the remote-control receiver 212B, thereby to prohibit transmission of the remote-control code from the receiving unit 20 to the second remote-control interface unit 202 (block S204). Then, the BIOS sends a command to the EC/KBC 121 to permit execution of the remote-control code process by the first remote-control interface unit 201 (block S205).

If the booted-up operating system is the OS#2 (NO in block S202), the BIOS sets the remote-control receiver 212B in an active state (e.g. power-on state) and permits the operation of the remote-control receiver 212B, thereby to permit transmission of the remote-control code from the receiving unit 20 to the second remote-control interface unit 202 (block S206). Then, the BIOS sends a command to the EC/KBC 121 to prohibit execution of the remote-control code process by the first remote-control interface unit 201 (block S207).

As has been described above, in the present embodiment, in accordance with the kind of operating system that is executed by the computer 10, the path for transmitting the remote-control code from the receiving unit 20 to the operating system is switched between the path extending through the first remote-control interface unit 201 and the path extending through the second remote-control interface unit 202. By virtue of this remote-control code transmission control function, the two operating systems (OS) can be controlled from the remote-control units by using the single receiving unit 20 built in the computer 10, that is, the single light-receiving unit 211 built in the computer 10.

To be more specific, in usual cases, as described above, dedicated light-receiving units need to be provided for the respective kinds of operating systems (OS's) in order to individually control a plurality of kinds of OS's from remote-control units. In the present embodiments, a plurality of OS's can be controlled by operations from remote-control units with use of the single light-receiving unit 211 that is built in the computer 10.

It is not necessary that the second remote-control interface unit 202 be realized by the USB controller. For example, the second remote-control interface unit 202 may be realized by a general-purpose I/O controller that is accessible from various OS's.

In the above-described embodiment, only one of the OS#1 and OS#2 is installed in the hard disk drive (HDD) 118. Alternatively, both of the OS#1 and OS#2 may be preinstalled in the hard disk drive (HDD) 118, and one of the OS#1 and OS#2 may selectively be booted up and executed by the computer 10.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a receiving unit configured to receive a remote-control code corresponding to at least one of a first remote-control code set and a second remote-control code set, the first code set supported by a first operating system and the second code set supported by a second operating system;
a first interface unit connected to the receiving unit and configured to induce the execution of the remote-control code by an operating system that is currently executed by the information processing apparatus when the remote-control code corresponds to the first code set;
a second interface unit connected to the receiving unit and configured to induce the execution of the remote-control code by the operating system that is currently executed by the information processing apparatus when the remote-control code corresponds to the second code set;
a determination unit configured to determine whether the operating system that is currently executed by the information processing apparatus corresponds to either the first operating system or the second operating system; and
a control unit configured to prohibit transmission of the remote-control code from the receiving unit to the second interface unit and to permit processing of the remote-control code by the first interface unit when it is determined that the operating system that is currently executed by the information processing apparatus is the first operating system, the control unit further configured to permit transmission of the remote-control code from the receiving unit to the second interface unit and to prohibit processing of the remote-control code by the first interface unit when it is determined that the operating system that is currently executed by the information processing apparatus is the second operating system.

2. The information processing apparatus according to claim 1, wherein each of the first code set and the second code set comprise at least one common code that can be executed by either the first operating system or the second operating system.

3. The information processing apparatus according to claim 1, wherein each of the first code set and the second code set comprise a power-on code, and wherein the first interface unit is configured to power-on the information processing apparatus when the first interface unit receives the power-on code corresponding to either the first code set or the second code set.

4. The information processing apparatus according to claim 1, wherein the receiving unit comprises:
a light-receiving unit configured to receive an infrared signal corresponding to at least one of a first received remote-control code belonging to the first code set and a second received remote-control code belonging to the second code set; and
a remote-control receiver configured to extract the first received code from the infrared signal and to transmit the first received code to the first interface unit, the remote-control receiver further configured to extract the second received code from the infrared signal and to transmit the second received code to the second interface unit, wherein the remote-control receiver is connected to the second interface unit via a switch circuit; and
wherein the control unit is configured to prohibit transmission of the second received code to the second interface unit by turning off the switch circuit when the operating system that is currently executed by the information processing apparatus corresponds to the first operating system, and wherein the control unit is configured to permit transmission of the second received code to the second interface unit by turning on the switch circuit when the operating system that is currently executed by the information processing apparatus corresponds to the second operating system.

5. The information processing apparatus according to claim 1, wherein the receiving unit comprises:
a light-receiving unit configured to receive an infrared signal corresponding to at least one of a first received remote-control code belonging to the first code set and a second received remote-control code belonging to the second code set;
a first remote-control receiver configured to extract the first received code from the infrared signal and to transmit the extracted first code to the first interface unit; and
a second remote-control receiver configured to extract the second received code from the infrared signal and to transmit the extracted second code to the second interface unit, and
wherein the control unit is configured to prohibit the second remote-control receiver from transmitting the extracted second code to the second interface unit when the operating system that is currently executed by the information processing apparatus corresponds to the first operating system, and wherein the control unit is configured to permit the second remote-control receiver to transmit the extracted second code to the second interface unit when the operating system that is currently executed by the information processing apparatus corresponds to the second operating system.

6. A remote-control code transmission control method for controlling transmission of a remote-control code to a processor currently executing an operating system in an information processing apparatus having a receiving unit configured to receive remote-control codes each corresponding to at least one of a first remote-control code set supported by a first operating system and a second remote-control code set supported by a second operating system, a first interface unit for processing the first code set, and a second interface unit for processing the second code set, the method comprising:
determining whether the currently executing operating system comprises the first operating system or the second operating system;
prohibiting transmission of remote-control codes from a receiving unit to the second interface unit and permitting the first interface unit to process the remote control code when the operating system that is currently executed by the information processing apparatus is determined to be the first operating system; and
permitting transmission of remote-control codes from the receiving unit to the second interface unit and prohibiting processing of remote-control codes by the first interface unit when the operating system that is currently executed by the information processing apparatus is determined to be the second operating system.

7. The remote-control code transmission control method according to claim 6, wherein each of the first remote-control code set and the second remote-control code set comprise at least one common code that can be executed by either the first operating system or the second operating system.

8. The remote-control code transmission control method according to claim 6, further comprising powering-on the information processing apparatus when the first interface unit receives via the receiving unit a power-on code corresponding to either the first code set or the second code set.

9. The remote-control code transmission control method according to claim 6, wherein the receiving unit comprises a light-receiving unit configured to receive an infrared signal corresponding to at least one of a first received remote-control code belonging to the first code set and a second received remote-control code belonging to the second code set, and a remote-control receiver configured to extract the first received code from the infrared signal and transmit the extracted first code to the first interface unit, and the remote control receiver configured to extract the second received code from the infrared signal and transmit the extracted second code to the second interface unit, wherein the remote-control receiver is connected to the second interface unit via a switch circuit;
wherein the step of prohibiting transmission comprises turning-off the switch circuit; and
wherein the step of permitting transmission comprises turning-on the switch circuit.

10. The remote-control code transmission control method according to claim 6, wherein the receiving unit comprises a light-receiving unit configured to receive an infrared signal corresponding to at least one of a first received remote-control code belonging to the first code set and a second received remote-control code belonging to the second code set, a first remote-control receiver configured to extract the first received code from the infrared signal and transmit the extracted first code to the first interface unit, and a second remote-control receiver configured to extract the second received code from the infrared signal and transmit the extracted second code to the second interface unit,
wherein the step of prohibiting transmission comprises prohibiting operation of the second remote-control receiver, and
wherein the step of permitting transmission comprises permitting operation of the second remote-control receiver.
